(19) United States
(12) Patent Application Publication
(10) Pub. No.: US 2023/0342235 A1
(43) Pub. Date: Oct. 26, 2023

(54) COMPUTER-READABLE RECORDING MEDIUM STORING INFORMATION PROCESSING PROGRAM, INFORMATION PROCESSING METHOD, AND SYSTEM

(71) Applicant: Fujitsu Limited, Kawasaki-shi (JP)

(72) Inventors: Yu KAWAGITA, Kawasaki (JP); Daiki YAMAKOSHI, Kawasaki (JP); Atsushi KUWABAYASHI, Machida (JP); MASATO ITO, Kawasaki (JP)

(73) Assignee: Fujitsu Limited, Kawasaki-shi (JP)

(21) Appl. No.: 18/157,095

(22) Filed: Jan. 20, 2023

(30) Foreign Application Priority Data
Apr. 26, 2022 (JP) 2022-072713

(51) Int. Cl. G06F 11/07; G06F 11/30

(52) U.S. Cl. CPC G06F 11/0766; G06F 11/3006

(57) ABSTRACT

A non-transitory computer-readable recording medium stores an information processing program for causing a computer to execute processing including: receiving a notification in response to an abnormality in a first system on a cloud; and blocking, in response to the reception of the notification, input and output of the first system by using a serverless function that creates a system by using resources on the cloud, and performing switch processing of creating, on the cloud, a second system to which a function of the first system is shifted.

### CROSS-REFERENCE TO RELATED APPLICATION

This application is based upon and claims the benefit of priority of the prior Japanese Patent Application No. 2022-72713, filed on Apr. 26, 2022, the entire contents of which are incorporated herein by reference.

### FIELD

The embodiment discussed herein is related to an information processing program, an information processing method, and a system.

### BACKGROUND

Since before, a cluster system may be constructed in a cloud environment. In the cluster system, a state called split brain occurs where a plurality of cluster nodes operates as an operation system at the same time, which may lead to data corruption in storage accessed by the operation system. Thus, it is desirable to take measures against the split brain.

Japanese Laid-open Patent Publication No. 2019-197352 and Japanese Laid-open Patent Publication No. 2014-170394 are disclosed as related art.

### SUMMARY

According to an aspect of the embodiments, a non-transitory computer-readable recording medium stores an information processing program for causing a computer to execute processing including: receiving a notification in response to an abnormality in a first system on a cloud; and blocking, in response to the reception of the notification, input and output of the first system by using a serverless function that creates a system by using resources on the cloud, and performing switch processing of creating, on the cloud, a second system to which a function of the first system is shifted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an arithmetic unit 201;

FIG. 4 is a block diagram illustrating a functional configuration example of the information processing system 200;

FIG. 5 is a block diagram illustrating a specific functional configuration example of the information processing system 200;

FIG. 6 is a flowchart illustrating an example of a block processing procedure;

FIG. 7 is a flowchart illustrating an example of a switch processing procedure;

FIG. 8 is a block diagram illustrating a specific functional configuration example of the information processing system 200 in a first operation example;

FIG. 9 is an explanatory diagram illustrating an example of an environment variable 860;

FIG. 10 is an explanatory diagram illustrating an example of an application programming interface (API);

FIG. 11 is an explanatory diagram illustrating an example of a status;

FIG. 12 is an explanatory diagram illustrating an example of instance information;

FIG. 13 is an explanatory diagram (part 1) illustrating an example of changing a security group;

FIG. 14 is an explanatory diagram (part 2) illustrating an example of changing the security group;

FIG. 15 is a flowchart (part 1) illustrating an example of an overall processing procedure;

FIG. 16 is a flowchart (part 2) illustrating an example of the overall processing procedure;

FIG. 17 is a block diagram illustrating a specific functional configuration example of the information processing system 200 in a second operation example;

FIG. 18 is an explanatory diagram illustrating an example of an item;

FIG. 19 is an explanatory diagram illustrating an example of a value of each item;

FIG. 20 is an explanatory diagram illustrating an example of an execution management object 1703;

FIG. 21 is a flowchart illustrating an example of a lock processing procedure;

FIG. 22 is a flowchart illustrating an example of a release processing procedure; and

FIG. 23 is a flowchart illustrating an example of a detection processing procedure.

### DESCRIPTION OF EMBODIMENTS

As related art, for example, there is a technology in which, in a case where stopping of a heartbeat and operation of a service are received from an operation system virtual server that detects the stopping of the heartbeat from a standby system virtual server, a coordination apparatus instructs the standby system virtual server to restart a system. Furthermore, for example, there is a technology in which, when a failure occurs in an active server, a control device of the active server initializes a disk input/output device and notifies to a standby server via a communication module.

However, in the related art, it is difficult to prevent data corruption in storage. For example, while an operation system recovers after a hang-up, a standby system erroneously shifts to the operation system in response to the hang-up, resulting in occurrence of a split brain that makes it not possible to prevent data corruption.

In one aspect, an embodiment aims to prevent data corruption.

Hereinafter, an embodiment of an information processing program, an information processing method, and a system will be described in detail with reference to the drawings.

(Example of Information Processing Method According to Embodiment)

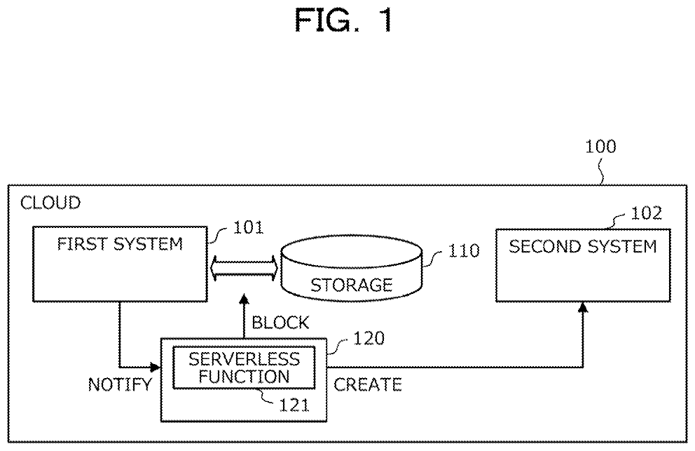

FIG. 1 is an explanatory diagram illustrating an example of the information processing method according to the embodiment. An information processing device 120 is a computer for managing a cluster system constructed in a cloud environment. The information processing device 120 is, for example, a server, a personal computer (PC), or the like.

In the cluster system, a state called split brain occurs where a plurality of cluster nodes operates as an operation system at the same time, which may lead to data corruption in storage accessed by the operation system. Thus, it is desirable to take measures against the split brain.

For example, a method 1 that uses an architecture called shoot the other node in the head (STONITH) to take measures against the split brain is conceivable. In the method 1, for example, a standby system forcibly powers off an operation system via a cloud application programming interface (API) in response to detecting an abnormality in the operation system.

Here, it is not possible in the method 1 to switch the standby system to a new operation system until it is confirmed that the operation system has been successfully powered off. Thus, the method 1 has a problem that it tends to increase a time needed to switch the standby system to the new operation system. Furthermore, the method 1 has a problem that the standby system is placed in a hot standby state in advance, which tends to increase a workload of an operator who sets the standby system. Furthermore, the method 1 has a problem that the standby system is placed in the hot standby state in advance, which tends to increase a cost of preparing the standby system. In the method 1, for example, resources that implement the standby system are secured in advance.

Furthermore, for example, a method 2 that uses an architecture called Quorum/Witness to take measures against the split brain is conceivable. In the method 2, for example, the operation system periodically updates an object file stored in a monitoring storage, and the standby system determines whether or not an abnormality in the operation system has correctly been detected by confirming the object file in response to detecting the abnormality in the operation system.

Here, it is conceivable that while the operation system recovers after a hang-up, the standby system erroneously shifts to the operation system in response to the hang-up. In this case, since the method 2 does not block input/output (IO) of the operation system, it is not possible to prevent the split brain from occurring. As a result, the method 2 has a problem that it is not possible to prevent data corruption. For example, in the method 2, the recovered operation system and the standby system that has been shifted to the new operation system access the same shared storage, which may lead to data corruption in the shared storage.

Thus, in the present embodiment, an information processing method capable of at least preventing data corruption will be described.

In FIG. 1, a first system 101 exists on a cloud 100. The first system 101 is created using resources on the cloud 100. The first system 101 is the operation system. The information processing device 120 exists on the cloud 100. The information processing device 120 has a serverless function 121. The serverless function 121 has a function of creating a system by using resources on the cloud 100.

(1-1) The information processing device 120 receives a notification in response to an abnormality in the first system 101 on the cloud 100. The notification indicates that an abnormality in first system 101 has occurred. The information processing device 120 receives the notification in response to the abnormality in the first system 101 from a monitoring unit that monitors the first system 101. The monitoring unit is implemented using, for example, resources on the cloud 100. The information processing device 120 may detect the abnormality in the first system 101 by its own device.

(1-2) The information processing device 120 blocks, in response to receiving the notification, input/output of the first system 101 by using the serverless function 121, and performs switch processing of creating, on the cloud 100, a second system 102 that shifts a function of the first system 101. The switch processing is processing for switching the operation system.

The information processing device 120 blocks input/output of the first system 101 by, for example, setting communication prohibition of the first system 101 to storage 110. The storage 110 has a storage area accessed by the first system 101 and the second system 102. The information processing device 120 discards, for example, the first system 101. The information processing device 120 performs, for example, the switch processing of creating the second system 102. For example, the information processing device 120 performs the switch processing of creating the second system and switching the operation system from the first system 101 to the created second system 102.

With this configuration, by shifting the function of the first system 101 to the second system 102 in a state where input/output of the first system 101 is blocked, the information processing device 120 may switch the operation system and prevent data corruption in the storage 110. The information processing device 120 may create the second system 102 before discarding the first system 101, at the stage where the communication prohibition of the first system 101 is set. Thus, the information processing device 120 may promote reduction in the time needed to switch the operation system.

Here, a case has been described where the information processing device 120 operates independently, but the present embodiment is not limited to this. For example, there may be a case where a plurality of computers cooperates to implement a function as the information processing device 120. For example, a third system that implements the function as the information processing device 120 described above may be created using resources on the cloud 100.

(Example of Information Processing System 200)

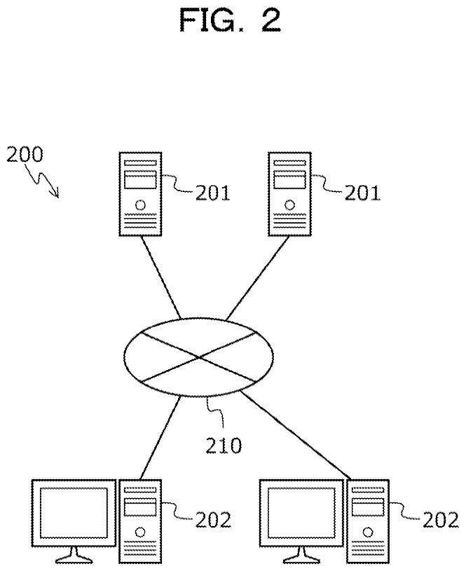

Next, an example of an information processing system 200 will be described with reference to FIG. 2.

FIG. 2 is an explanatory diagram illustrating an example of the information processing system 200. In FIG. 2, the information processing system 200 includes a plurality of arithmetic units 201 and one or more client devices 202.

In the information processing system 200, the arithmetic units 201 and the client devices 202 are connected via a wired or wireless network 210. The network 210 is, for example, a local area network (LAN), a wide area network (WAN), the Internet, or the like.

The arithmetic unit 201 is a computer that serves as a resource forming various systems. The various systems are, for example, individual systems included in the information processing system 200. For example, the various systems include the first system and the second system illustrated in FIG. 1, and the like. For example, the various systems include the third system described above. The third system is created by, for example, one or a plurality of arithmetic units 201. For example, the third system implements the function as the information processing device 120 described above. The arithmetic unit 201 is, for example, a server, a PC, or the like.

The client device 202 is a computer used by a user who uses the various systems. The client device 202 uses the various systems by, for example, accessing the various systems based on operation input by the user. The client device 202 is, for example, a PC, a tablet terminal, a smartphone, or the like.

Here, a case has been described where the arithmetic unit 201 and the client device 202 are different devices, but the present embodiment is not limited to this. For example, there may be a case where the arithmetic unit 201 has a function as the client device 202, and may be operable as the client device 202.

(Hardware Configuration Example of Arithmetic Unit 201)

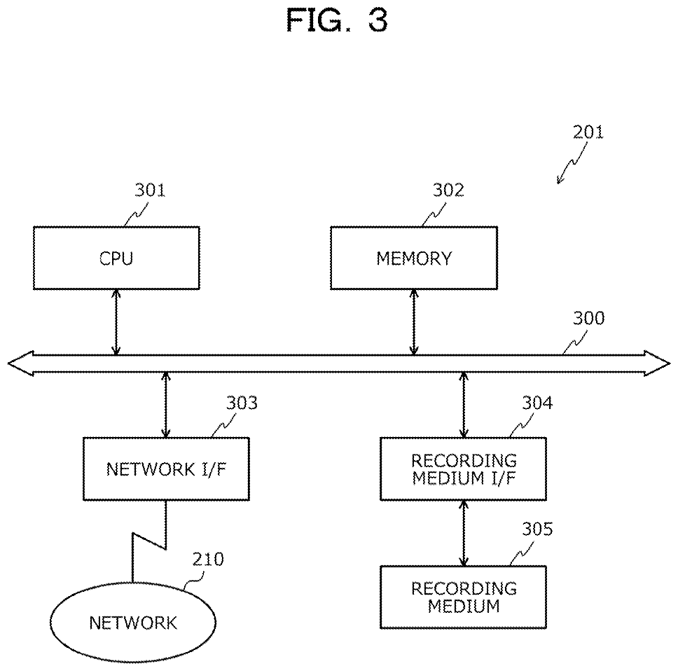

Next, a hardware configuration example of the arithmetic unit 201 will be described with reference to FIG. 3.

FIG. 3 is a block diagram illustrating the hardware configuration example of the arithmetic unit 201. In FIG. 3, the arithmetic unit 201 includes a central processing unit (CPU) 301, a memory 302, a network interface (I/F) 303, a recording medium I/F 304, and a recording medium 305. Furthermore, the individual components are coupled to each other by a bus 300.

Here, the CPU 301 is in charge of overall control of the arithmetic unit 201. The memory 302 includes, for example, a read only memory (ROM), a random access memory (RAM), a flash ROM, and the like. For example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is coupled to the network 210 through a communication line, and is coupled to another computer via the network 210. Additionally, the network I/F 303 manages an interface between the network 210 and the inside, and controls input/output of data from another computer. The network I/F 303 is, for example, a modem, a LAN adapter, or the like.

The recording medium I/F 304 controls reading/writing of data from/to the recording medium 305 under the control of the CPU 301. The recording medium I/F 304 is, for example, a disk drive, a solid state drive (SSD), a universal serial bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be attachable to and detachable from the arithmetic unit 201.

The arithmetic unit 201 may include, for example, a keyboard, a mouse, a display, a printer, a scanner, a microphone, a speaker, or the like in addition to the components described above. Furthermore, the arithmetic unit 201 may include a plurality of the recording medium I/Fs 304 and the recording media 305. Furthermore, the arithmetic unit 201 does not need to include the recording medium I/F 304 and the recording medium 305.

(Hardware Configuration Example of Client Device 202)

Since a hardware configuration example of the client device 202 is, for example, similar to the hardware configuration example of the arithmetic unit 201 illustrated in FIG. 3, description thereof is omitted.

(Functional Configuration Example of Information Processing System 200)

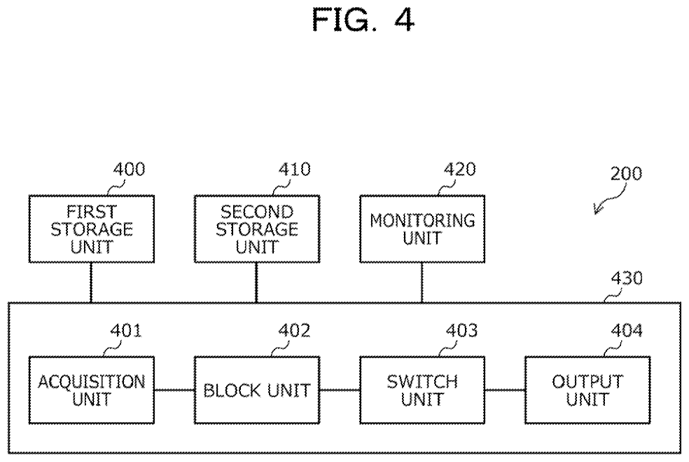

Next, a functional configuration example of the information processing system 200 will be described with reference to FIG. 4.

FIG. 4 is a block diagram illustrating the functional configuration example of the information processing system 200. The information processing system 200 includes a first storage unit 400, a second storage unit 410, a monitoring unit 420, an acquisition unit 401, a block unit 402, a switch unit 403, and an output unit 404.

The first storage unit 400 is implemented by, for example, a storage area such as the memory 302 or the recording medium 305 illustrated in FIG. 3. Hereinafter, a case will be described where the first storage unit 400 is included in any one of the arithmetic units 201, but the present embodiment is not limited to this. For example, there may be a case where the first storage unit 400 is included in a device different from the arithmetic unit 201, and content stored in the first storage unit 400 may be referred to by at least any one of the arithmetic units 201.

The second storage unit 410 is implemented by, for example, a storage area such as the memory 302 or the recording medium 305 illustrated in FIG. 3. Hereinafter, a case will be described where the second storage unit 410 is included in any one of the arithmetic units 201, but the present embodiment is not limited to this. For example, there may be a case where the second storage unit 410 is included in a device different from the arithmetic unit 201, and content stored in the second storage unit 410 may be referred to by at least any one of the arithmetic units 201.

For example, the monitoring unit 420 implements a function thereof by causing the CPU 301 to execute a program in any one of the arithmetic units 201 or by the network I/F 303. The program is stored in, for example, a storage area such as the memory 302 or the recording medium 305 illustrated in FIG. 3. A processing result of the monitoring unit 420 is stored in, for example, a storage area such as the memory 302 or the recording medium 305 illustrated in FIG. 3 in any one of the arithmetic units 201.

The acquisition unit 401 to the output unit 404 function as an example of a control unit 430. For example, the acquisition unit 401 to the output unit 404 implement functions thereof by causing the CPU 301 to execute a program in any one of the arithmetic units 201 or by the network I/F 303. The program is stored in, for example, the memory 302, the recording medium 305, or the like illustrated in FIG. 3. A processing result of each functional unit is stored in, for example, a storage area such as the memory 302 or the recording medium 305 illustrated in FIG. 3 in any one of the arithmetic units 201.

The first storage unit 400 stores various types of information to be referred to or updated in processing of each functional unit. The first storage unit 400 stores information indicating parameters of a system on the cloud, or the like. The first storage unit 400 stores, for example, information indicating parameters or the like of a first system on the cloud. The first system is, for example, a virtual server. The parameters include, for example, a virtual machine image that implements a system on the cloud, or the like.

The second storage unit 410 stores various types of information to be referred to or updated in processing of a system on the cloud. The second storage unit 410 is, for example, storage. The second storage unit 410 stores, for example, various types of information to be referred to or updated in processing of the first system on the cloud. For example, in a case where a second system to which a function of the first system is shifted is created on the cloud, the various types of information is further referred to or updated in processing of the second system.

The monitoring unit 420 monitors a system on the cloud. The monitoring unit 420 monitors, for example, the first system on the cloud. For example, the monitoring unit 420 monitors whether or not an abnormality occurs in the first system. For example, in a case where an abnormality has occurred in the first system, the monitoring unit 420 outputs a notification in response to the abnormality in the first system. For example, the monitoring unit 420 outputs the notification in response to the abnormality in the first system so that the acquisition unit 401 may acquire the notification.

The acquisition unit 401 acquires various types of information to be used for processing of each functional unit. The acquisition unit 401 stores the acquired various types of information in the first storage unit 400 or outputs the acquired various types of information to each functional unit. Furthermore, the acquisition unit 401 may output the various types of information stored in the first storage unit 400 to each functional unit. The acquisition unit 401 acquires the various types of information based on, for example, operation input by a user. The acquisition unit 401 may receive the various types of information from, for example, a device different from the arithmetic unit 201.

The acquisition unit 401 receives a notification in response to an abnormality in the first system. The acquisition unit 401 receives the notification in response to the abnormality in the first system from, for example, the monitoring unit 420.

The acquisition unit 401 may receive a start trigger to start processing of any one of the functional units. The start trigger is, for example, predetermined operation input by a user. The start trigger may be, for example, reception of predetermined information from another computer. The start trigger may be, for example, output of predetermined information by any one of the functional units. The acquisition unit 401 receives, for example, reception of the notification in response to the abnormality in the first system as a start trigger to start processing of the block unit 402 and the switch unit 403.

The block unit 402 blocks input/output of the first system by using a serverless function in response to receiving a notification. The serverless function has, for example, a function of creating a system by using resources on the cloud. The serverless function has, for example, a function of controlling input/output of the system.

The block unit 402 blocks input/output of the first system by, for example, using the serverless function to set communication prohibition of the first system in response to receiving the notification. For example, the block unit 402 blocks input/output of the first system by using the serverless function to set output prohibition of the first system to the second storage unit 410 in response to receiving the notification. With this configuration, the block unit 402 may prevent data corruption in the second storage unit 410.

For example, in a case where the notification in response to the abnormality in the first system is received a plurality of times, it is preferable that the block unit 402 blocks input/output of the first system in response to receiving a first notification, and does not block input/output of the first system in response to receiving second and subsequent notifications. With this configuration, the block unit 402 may prevent block processing of blocking input/output of the first system from being performed redundantly, and may promote improvement in stability of the information processing system 200.

Moreover, the block unit 402 uses the serverless function to discard the first system. The block unit 402 discards the first system after successfully setting communication prohibition of the first system, for example. The block unit 402 may discard the first system while setting communication prohibition of the first system, for example. For example, the block unit 402 may discard the first system after failing to set communication prohibition of the first system. For example, the block unit 402 discards the first system by issuing a request to discard the first system. With this configuration, the block unit 402 may prevent data corruption in the second storage unit 410. The block unit 402 may save a resource use amount in the information processing system 200.

The switch unit 403 performs the switch processing of creating, on the cloud, the second system to which the function of the first system is shifted. The second system is, for example, a virtual server. The switch processing includes switching a distribution destination of communication from the first system to the second system. The switch unit 403 performs, for example, the switch processing of creating the second system that takes over information indicating the parameters or the like of the first system. With this configuration, the switch unit 403 may shift the function of the first system to the second system, and may continue to appropriately provide the function to the client device 202.

For example, in a case where communication prohibition of the first system has been successfully set by the block unit 402, the switch unit 403 performs the switch processing of creating the second system without waiting for completion of discard of the first system. With this configuration, the switch unit 403 may promote shortening of a time needed to create the second system.

For example, in a case where communication prohibition of the first system has failed to be set by the block unit 402, the switch unit 403 performs the switch processing of creating the second system after completion of discard of the first system by the block unit 402. With this configuration, the switch unit 403 may prevent data corruption in the second storage unit 410.

For example, in a case where a notification in response to an abnormality in the first system is received a plurality of times, it is preferable that the switch unit 403 performs the switch processing in response to receiving a first notification, and does not perform the switch processing in response to receiving second and subsequent notifications. With this configuration, the switch unit 403 may prevent the switch processing from being performed redundantly, and may promote improvement in stability of the information processing system 200.

The output unit 404 outputs a processing result of at least any one of the functional units. An output format is, for example, display on a display, print output to a printer, transmission to an external device by the network I/F 303, or storage in a storage area such as the memory 302 or the recording medium 305. With this configuration, the output unit 404 may make it possible for a user to be notified of a processing result of at least any one of the functional units, and may promote improvement in convenience of the information processing system 200.

The output unit 404 outputs a notification in response to an abnormality in the first system. With this configuration, the output unit 404 may make it possible for a user to grasp occurrence of the abnormality in the first system.

The output unit 404 outputs a notification that the block processing has been successfully performed. The output unit 404 may output, for example, a notification that the block processing has failed to be performed. With this configuration, the output unit 404 may make it possible for a user to grasp whether or not the block processing has been successfully performed.

The output unit 404 outputs a notification that the switch processing has been successfully performed. The output unit 404 may output, for example, a notification that the switch processing has failed to be performed. With this configuration, the output unit 404 may make it possible for a user to grasp whether or not the switch processing has been successfully performed.

(Flow of Operation of Information Processing System 200)

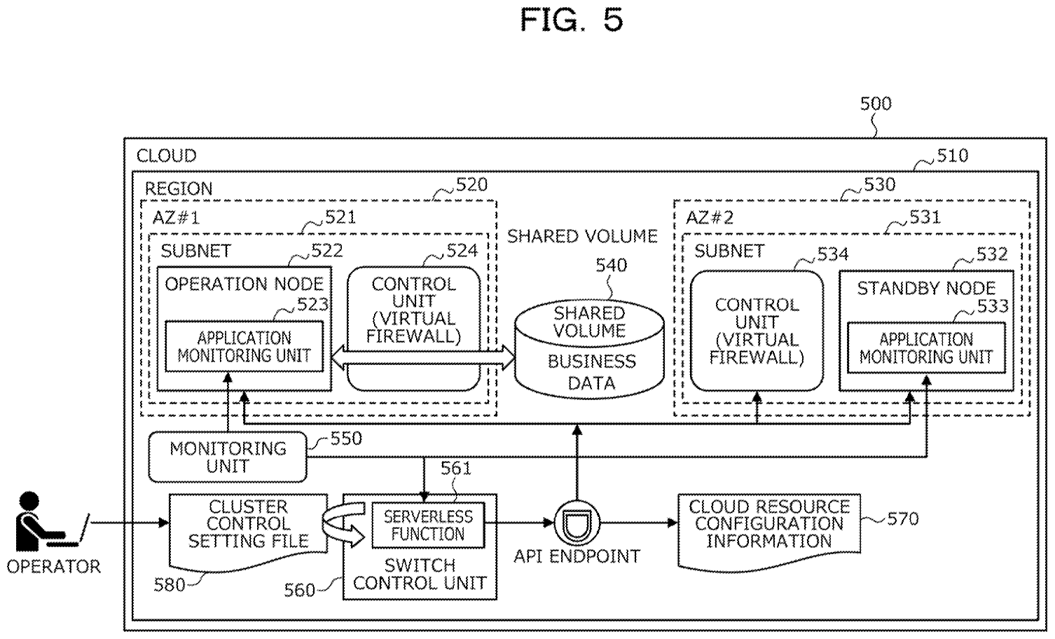

Next, with reference to FIG. 5, a specific functional configuration example of the information processing system 200 will be indicated, and a flow of operation of the information processing system 200 will be described.

FIG. 5 is a block diagram illustrating the specific functional configuration example of the information processing system 200. In FIG. 5, a cloud 500 including a plurality of resources exists. The resources are, for example, arithmetic resources, storage resources, or the like. The resources are implemented by, for example, the arithmetic unit 201. The cloud 500 is implemented by, for example, Amazon Web Service (AWS). Here, Amazon is a registered trademark.

The cloud 500 includes a region 510. The region 510 indicates an area. The region 510 includes an availability zone (AZ) 520 and an AZ 530. The AZ 520 is, for example, a collection of data centers. The AZ 530 is, for example, a collection of data centers.

The AZ 520 includes a subnet 521. The subnet 521 is a range in which an Internet protocol (IP) address is allocated. The subnet 521 includes an operation node 522.

The operation node 522 is a system that operates as the operation system. The operation node 522 is a service system that provides a predetermined function to a user as the operation system. The operation node 522 executes, for example, a business application. The operation node 522 provides a predetermined function to a user by, for example, executing the business application. The operation node 522 is, for example, a virtual server. The operation node 522 is implemented by, for example, resources included in the cloud 500. For example, the operation node 522 is implemented by resources included in the AZ 520 of the cloud 500.

The operation node 522 includes an application monitoring unit 523. The subnet 521 includes a control unit 524. The control unit 524 is, for example, a control system that controls traffic between the operation node 522 and a shared volume 540. The control unit 524 is, for example, a virtual firewall.

The region 510 includes the shared volume 540. The shared volume 540 is implemented by, for example, resources included in the cloud 500. The shared volume 540 is, for example, storage that stores business data handled by a business application. The region 510 includes a monitoring unit 550. The monitoring unit 550 is implemented by, for example, resources included in the cloud 500.

The region 510 includes a switch control unit 560. The switch control unit 560 is a control system for switching the operation system. The switch control unit 560 includes a serverless function 561. The serverless function 561 is, for example, AWS Lambda defined by the AWS. The switch control unit 560 is implemented by, for example, resources included in the cloud 500.

The application monitoring unit 523 is a monitoring system that monitors a business application executed by the operation node 522 and detects an abnormality in the business application. When the abnormality in the business application is detected, the application monitoring unit 523 transmits, to the monitoring unit 550, a notification that the abnormality in the business application has been detected.

The monitoring unit 550 is a monitoring system that monitors the operation node 522 and detects an abnormality in the operation node 522. The abnormality in the operation node 522 is an abnormality in the operation node 522 itself, an abnormality in a business application executed by the operation node 522, or the like.

The monitoring unit 550 detects the abnormality in the operation node 522 by receiving, from the application monitoring unit 523, a notification that the abnormality in the business application has been detected. The monitoring unit 550 may, for example, perform polling to the operation node 522, and detect the abnormality in the operation node 522 itself. When the abnormality in the operation node 522 is detected, the monitoring unit 550 transmits, to the switch control unit 560, a switch request including the notification that the abnormality in the operation node 522 has been detected.

The switch control unit 560 receives a setting file 580 for cluster control via the client device 202 used by an operator. The setting file 580 includes various parameters referred to by the switch control unit 560. The setting file 580 includes, for example, an identifier of the operation node 522 to be subjected to the switch processing. The identifier of the operation node 522 is set by, for example, the operator.

The setting file 580 includes, for example, a traffic control rule for TO blocking. The traffic control rule for TO blocking is, for example, a control rule for rejecting communication of the operation node 522 to be subjected to the switch processing. For example, the traffic control rule for TO blocking includes a black hole security group (BHSG). The traffic control rule for TO blocking is set by, for example, the operator.

By receiving a switch request, the switch control unit 560 determines that an abnormality in the operation node 522 to be subjected to the switch processing has been detected, and performs the switch processing. The switch control unit 560 controls the control unit 524 to reject communication of the operation node 522 in which the abnormality has been detected, at least to the shared volume 540, according to the traffic control rule for IO blocking.

For example, the switch control unit 560 transmits, to the control unit 524, a change request requesting that a rule referred to by the control unit 524 be changed to the traffic control rule for IO blocking. For example, the switch control unit 560 applies the BHSG to the control unit 524 by transmitting the change request to the control unit 524.

When the operation node 522 is normal, the control unit 524 controls various types of traffic related to the operation node 522 based on a normal-time traffic control rule that permits communication of the operation node 522. When the operation node 522 is abnormal, the control unit 524 blocks the various types of traffic related to the operation node 522 based on the traffic control rule for IO blocking under the control of the switch control unit 560. With this configuration, the control unit 524 may avoid that the operation node 522 writes data to the shared volume 540, and may prevent data corruption in the shared volume 540.

The switch control unit 560 controls the cloud 500 to discard the operation node 522 after transmitting the change request. For example, the switch control unit 560 issues, to the cloud 500, a discard request requesting that the operation node 522 be discarded. With this configuration, the switch control unit 560 may prevent data corruption in the shared volume 540.

When communication of the operation node 522 to the shared volume 540 has been successfully rejected by the change request, the switch control unit 560 may perform the switch processing without waiting for completion of discard of the operation node 522. For example, in the switch processing, the switch control unit 560 creates a subnet 531 on the AZ 530, refers to cloud resource configuration information 570, and creates a standby node 532 and a control unit 534 on the subnet 531 via an API endpoint.

The subnet 531 is a range in which an IP address is allocated. The standby node 532 corresponds to, for example, a copy of the operation node 522. The standby node 532 is a system that operates as the operation system, in place of the operation node 522. The standby node 532 is a service system that provides a predetermined function to a user as the operation system.

The standby node 532 executes, for example, a business application. The standby node 532 provides a predetermined function to a user by, for example, executing the business application. For example, the standby node 532 executes a business application having the same function as the business application executed by the operation node 522. The standby node 532 is, for example, a virtual server. The standby node 532 is implemented by, for example, resources included in the cloud 500. For example, the standby node 532 is implemented by resources included in the AZ 530 of the cloud 500.

The standby node 532 includes an application monitoring unit 533. The control unit 534 is, for example, a virtual firewall. The cloud resource configuration information 570 includes configuration information parameters of the operation node 522. The cloud resource configuration information 570 is implemented by, for example, resources included in the cloud 500. For example, the cloud resource configuration information 570 is implemented by resources included in the region 510 of the cloud 500.

The switch control unit 560 switches the operation system from the operation node 522 to the standby node 532 in the switch processing. The switch control unit 560 controls the monitoring unit 550 so that the monitoring unit 550 monitors the standby node 532 in the switch processing. With this configuration, the switch control unit 560 may continue to operate the operation system appropriately, and may continue to operate the information processing system 200 appropriately. The switch control unit 560 may perform the switch processing without waiting for completion of discard of the operation node 522, and may facilitate early switching of the operation system from the operation node 522 to the standby node 532.

When communication of the operation node 522 to the shared volume 540 is not successfully rejected by the change request, the switch control unit 560 waits for completion of discard of the operation node 522 and then performs the switch processing. With this configuration, the switch control unit 560 may continue to operate the operation system appropriately, and may continue to operate the information processing system 200 appropriately. The switch control unit 560 may prevent data corruption in the shared volume 540.

In this way, the information processing system 200 may prohibit communication of the operation node 522 to the shared volume 540 without the operation nodes 522 and 532 as a main body, and may prevent data corruption in the shared volume 540.

For example, since before, it is conceivable that an operation node prepared as a standby system prohibits communication with storage of an operation node which serves as a current operation system and for which it is determined that an abnormality has occurred. Thus, it may not be possible to prevent data corruption in the storage when a hang-up or the like occurs in the operation node serving as the current operation system.

On the other hand, the information processing system 200 may prohibit communication of the operation node 522 by the external serverless function 561 without the operation nodes 522 and 532 as a main body. Thus, the information processing system 200 may prevent a split brain even in the case of occurrence of a hang-up in the operation node 522, or the like, and may appropriately prevent data corruption in the shared volume 540.

While preventing data corruption in the shared volume 540, the information processing system 200 may discard the operation node 522 in which an abnormality has occurred, create the standby node 532 in place of the operation node 522, and switch the operation system. The information processing system 200 may dispense with preparing the standby node 532 in advance. As a result, the information processing system 200 may promote reduction in a workload imposed on an operator. Furthermore, the information processing system 200 may save a resource use amount of the cloud 500 until the standby node 532 is created when it is actually used.

(Block Processing Procedure)

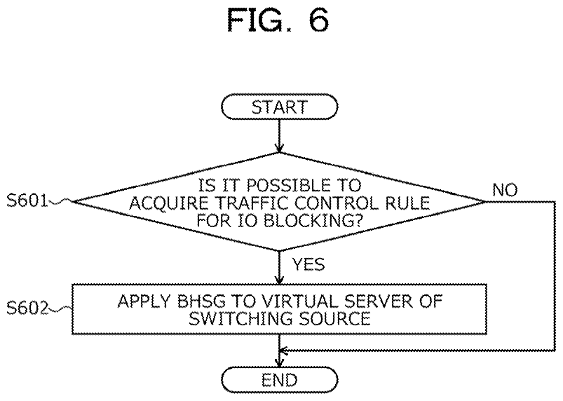

Next, an example of a block processing procedure executed by the information processing system 200 will be described with reference to FIG. 6.

FIG. 6 is a flowchart illustrating an example of the block processing procedure. In FIG. 6, the switch control unit 560 determines whether or not it is possible to acquire the traffic control rule for IO blocking (Step S601). Here, in a case where it is not possible to acquire the traffic control rule for IO blocking (Step S601: No), the switch control unit 560 ends the block processing.

On the other hand, in a case where it is possible to acquire the traffic control rule for IO blocking (Step S601: Yes), the switch control unit 560 acquires the traffic control rule for IO blocking. Then, the switch control unit 560 applies the BHSG to a virtual server of a switching source according to the acquired traffic control rule for IO blocking (Step S602). Then, the switch control unit 560 ends the block processing.

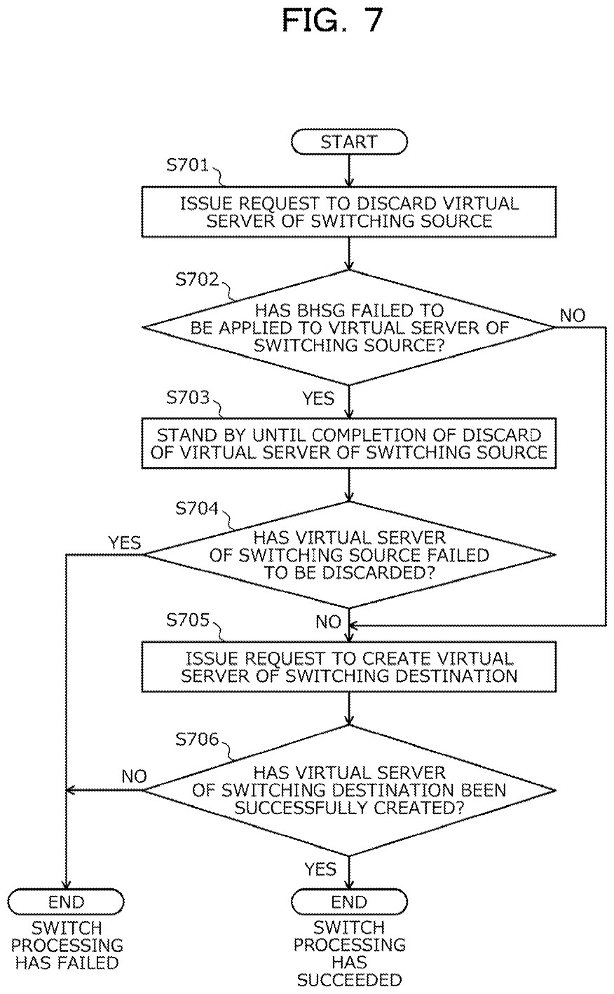

With this configuration, when the BHSG has been successfully applied, the switch control unit 560 may prevent data corruption in storage with which the virtual server of the switching source communicates. After the block processing, the switch control unit 560 executes the switch processing to be described later with reference to FIG. 7. The switch control unit 560 may execute the switch processing to be described later with reference to FIG. 7 even when application of the BHSG has failed.

(Switch Processing Procedure)

Next, an example of a switch processing procedure executed by the information processing system 200 will be described with reference to FIG. 7.

FIG. 7 is a flowchart illustrating an example of the switch processing procedure. In FIG. 7, the switch control unit 560 issues a request to discard the virtual server of the switching source to the cloud 500 (Step S701).

Next, the switch control unit 560 determines whether or not the BHSG has failed to be applied to the virtual server of the switching source (Step S702). Here, in a case where the application has succeeded (Step S702: No), the switch control unit 560 proceeds to processing in Step S705. On the other hand, in a case where the application has failed (Step S702: Yes), the switch control unit 560 proceeds to processing in Step S703.

In Step S703, the switch control unit 560 stands by until completion of discard of the virtual server of the switching source (Step S703). With this configuration, regardless of whether the application of the BHSG is correct or not, the switch control unit 560 may prevent data corruption in the storage with which the virtual server of the switching source communicates.

Next, the switch control unit 560 determines whether or not the virtual server of the switching source has failed to be discarded (Step S704). Here, in a case where the discard has failed (Step S704: Yes), the switch control unit 560 determines that the switch processing has failed, outputs a notification indicating that the switch processing has failed, and ends the switch processing. On the other hand, in a case where the discard has succeeded (Step S704: No), the switch control unit 560 proceeds to the processing in Step S705.

In Step S705, the switch control unit 560 issues a request to create a virtual server of a switching destination, and creates the virtual server of the switching destination on the cloud 500 (Step S705). In Step S705, the switch control unit 560 may create the virtual server of the switching destination on the cloud 500 even when the virtual server of the switching source has failed to be discarded.

Next, the switch control unit 560 determines whether or not the virtual server of the switching destination has been successfully created (Step S706). Here, in a case where the creation has failed (Step S706: No), the switch control unit 560 determines that the switch processing has failed, outputs a notification indicating that the switch processing has failed, and ends the switch processing. On the other hand, in a case where the creation has succeeded (Step S706: Yes), the switch control unit 560 determines that the switch processing has succeeded, and ends the switch processing. With this configuration, the switch control unit 560 may appropriately switch the operation system.

(First Operation Example of Information Processing System 200)

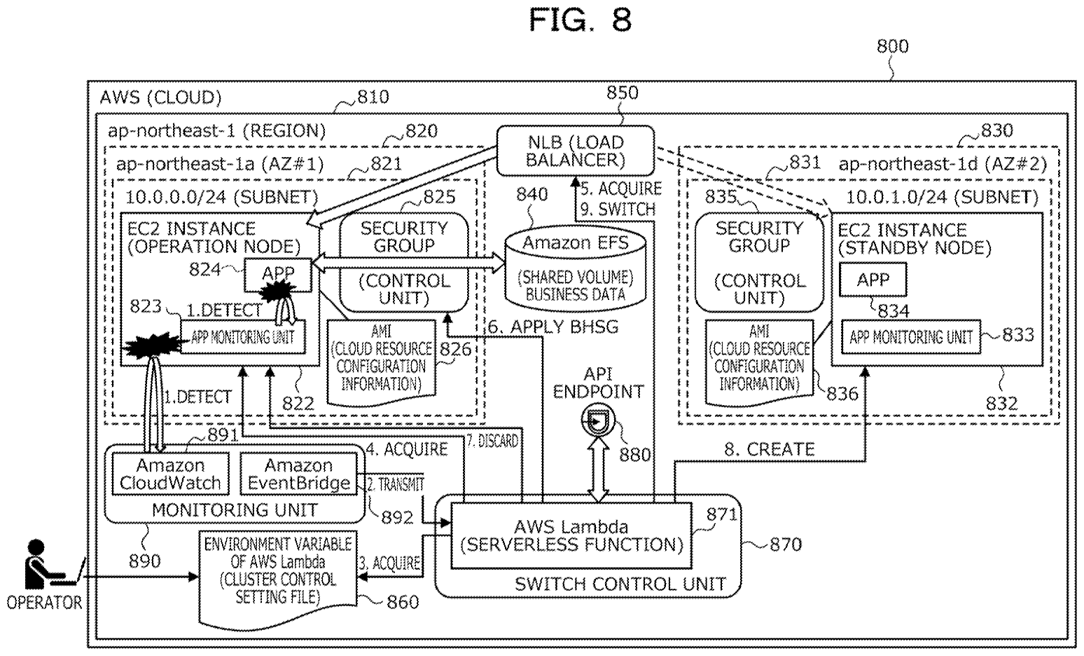

Next, a first operation example of the information processing system 200 will be described with reference to FIGS. 8 to 14.

FIG. 8 is a block diagram illustrating a specific functional configuration example of the information processing system 200 in the first operation example. In FIG. 8, a cloud 800 “AWS” including a plurality of resources exists. The resources are, for example, arithmetic resources, storage resources, or the like. The resources are implemented by, for example, the arithmetic unit 201.

The cloud 800 includes a region 810 “ap-northeast-1”. The region 810 includes an AZ 820 “ap-northeast-1a” and an AZ 830 “ap-northeast-1d”. The AZ 820 is, for example, a collection of data centers. The AZ 830 is, for example, a collection of data centers.

The AZ 820 includes a subnet 821. The subnet 821 is a range in which an IP address “10.0.0.0/24” is allocated. The subnet 821 includes an operation node 822 “elastic compute cloud (EC2) instance”. The operation node 822 executes, for example, an app 824 which is a business application. The operation node 822 is, for example, a virtual server. The operation node 822 is implemented by, for example, resources included in the cloud 800. For example, the operation node 822 is implemented by resources included in the AZ 820 of the cloud 800. The operation node 822 includes an app monitoring unit 823.

The subnet 821 includes a control unit 825 “security group”. The control unit 825 is, for example, a virtual firewall. The subnet 821 includes cloud resource configuration information 826 “Amazon Machine Image (AMI)”. The cloud resource configuration information 826 is information that includes an attribute value of the operation node 822 and makes it possible to replicate the operation node 822. The cloud resource configuration information 826 includes configuration information parameters of the operation node 822. The cloud resource configuration information 826 is implemented by, for example, resources included in the cloud 800. For example, the cloud resource configuration information 826 is implemented by resources included in the region 810 of the cloud 800.

The region 810 includes a shared volume 840 “Amazon Elastic File System (EFS)”. The shared volume 840 is implemented by, for example, resources included in the cloud 800. The shared volume 840 is, for example, storage that stores business data handled by the app 824. The region 810 includes a load balancer 850 “network load balancer (NLB)”. The load balancer 850 is a mechanism for leveling a load imposed on the operation node 822 and the like.

The region 810 has an environment variable 860 for the AWS Lambda. The environment variable 860 is stored using resources included in the region 810. The environment variable 860 is set by an operator. The environment variable 860 includes various parameters referred to by a switch control unit 870. The environment variable 860 includes, for example, an identifier of the operation node 822 to be subjected to the switch processing. The identifier of the operation node 822 is set by, for example, the operator.

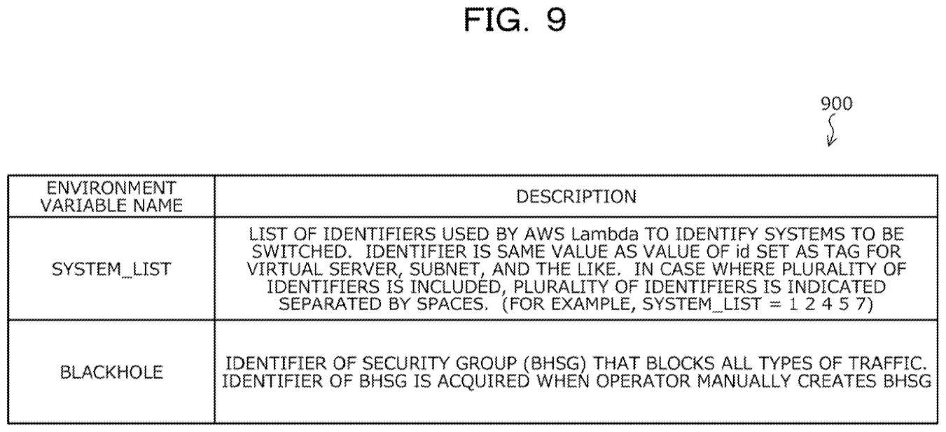

The environment variable 860 includes, for example, a traffic control rule for IO blocking. The traffic control rule for IO blocking is, for example, a control rule for rejecting communication of the operation node 822 to be subjected to the switch processing. For example, the traffic control rule for IO blocking includes a black hole security group (BHSG). The traffic control rule for IO blocking is set by, for example, the operator. Here, description of FIG. 9 will be made, and an example of the environment variable 860 will be described.

FIG. 9 is an explanatory diagram illustrating an example of the environment variable 860. As indicated in a table 900 of FIG. 9, the environment variable 860 includes SYSTEM_LIST. The SYSTEM_LIST is a list of identifiers used by the AWS Lambda to identify systems to be switched. The system is, for example, a virtual server or the like. The identifier is, for example, the same value as a value of id set as a tag for a virtual server, a subnet, and the like. For example, in a case where a plurality of identifiers is included, the SYSTEM_LIST indicates the plurality of identifiers separated by spaces. For example, the SYSTEM_LIST=1 2 4 5 7.

The environment variable 860 includes BLACKHOLE. The BLACKHOLE includes an identifier of a security group (BHSG) that blocks all types of traffic. The BLACKHOLE in the environment variable 860 is set by acquiring the identifier of the BHSG when the operator manually creates the BHSG.

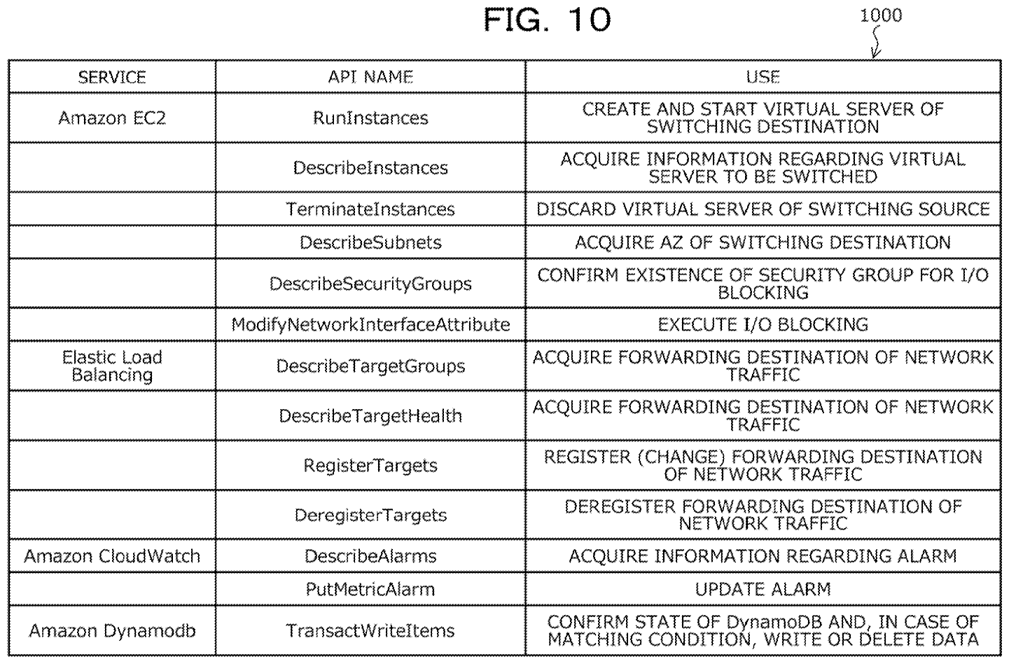

Returning to the description of FIG. 8, the region 810 includes the switch control unit 870. The switch control unit 870 includes a serverless function 871 “AWS Lambda”. The serverless function 871 is, for example, the AWS Lambda defined by the AWS. The switch control unit 870 is implemented by, for example, resources included in the cloud 800. An API endpoint 880 exists. The API endpoint 880 is a uniform resource identifier (URI) for accessing an API. Next, description of FIG. 10 will be made, and an example of the API will be described.

FIG. 10 is an explanatory diagram illustrating an example of the API. As indicated in a table 1000 of FIG. 10, various APIs exist. The serverless function 871 may use various APIs.

As indicated in the table 1000, for example, an Amazon EC2-related API “RunInstances” is an API that creates and starts a virtual server of a switching destination. For example, an Amazon EC2-related API “DescribeInstances” is an API that acquires information regarding a virtual server to be switched. For example, an Amazon EC2-related API “TerminateInstances” is an API that discards a virtual server of a switching source.

For example, an Amazon EC2-related API “DescribeSubnets” is an API that acquires an AZ of a switching destination. For example, an Amazon EC2-related API “DescribeSecurityGroups” is an API that confirms existence of a security group for IO blocking. For example, an Amazon EC2-related API “ModifyNetworkInterfaceAttribute” is an API that executes IO blocking.

For example, an Elastic Load Balancing-related API “DescribeTargetGroups” is an API that acquires a forwarding destination of network traffic. For example, an Elastic Load Balancing-related API “DescribeTargetHealth” is an API that acquires a forwarding destination of network traffic.

For example, an Elastic Load Balancing-related API “RegisterTargets” is an API that registers a forwarding destination of network traffic. For example, an Elastic Load Balancing-related API “DeregisterTargets” is an API that deregisters a forwarding destination of network traffic.

For example, an Amazon CloudWatch-related API “DescribeAlarms” is an API that acquires information regarding an alarm. For example, an Amazon CloudWatch-related API “PutMetricAlarm” is an API that updates an alarm. For example, an Amazon Dynamodb-related API “TransactWriteItems” is an API that confirms a state of the DynamoDB and, in a case where the confirmed state matches a condition, writes or deletes data to the DynamoDB.

Here, returning to the description of FIG. 8, the region 810 includes a monitoring unit 890. The monitoring unit 890 includes Amazon CloudWatch 891 and Amazon EventBridge 892. The monitoring unit 890 is implemented by, for example, resources included in the cloud 800. The Amazon CloudWatch 891 manages a status of a CloudWatch alarm indicating a state of a virtual server to be monitored.

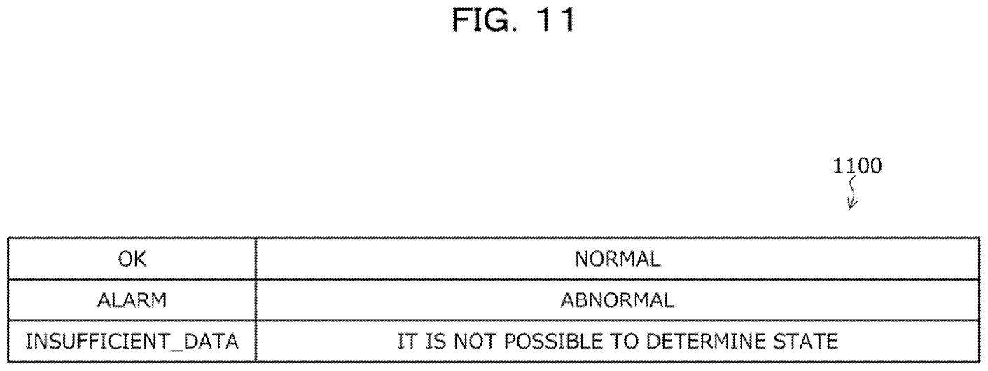

In the following description, the Amazon CloudWatch 891 may be referred to as “CloudWatch 891”. In the following description, the Amazon EventBridge 892 may be referred to as “EventBridge 892”. Next, an example of the status of the CloudWatch alarm will be described with reference to FIG. 11.

FIG. 11 is an explanatory diagram illustrating an example of the status. As indicated in a table 1100 of FIG. 11, the status is, for example, OK. The OK indicates that the virtual server to be monitored is normal. The status is, for example, ALARM. The ALARM indicates that the virtual server to be monitored is abnormal.

The status is, for example, INSUFFICIENT_DATA. The INSUFFICIENT_DATA indicates that it is not possible to determine the state of the virtual server to be monitored. The INSUFFICIENT_DATA indicates that it is not possible to determine the state of the virtual server because, for example, it is not possible to use metrics related to the virtual server or data for metrics related to the virtual server is insufficient.

Returning to the description of FIG. 8, the app monitoring unit 823 is a monitoring system that monitors the app 824 executed by the operation node 822 and detects an abnormality in the app 824. The monitoring unit 890 is a monitoring system that monitors the operation node 822 by the CloudWatch 891 and detects an abnormality in the operation node 822. The abnormality in the operation node 822 is an abnormality in the operation node 822 itself, an abnormality in the app 824 executed by the operation node 822, or the like.

(8-1) When the abnormality in the app 824 is detected, the app monitoring unit 823 transmits, to the monitoring unit 890, a notification that the abnormality in the app 824 has been detected. The monitoring unit 890 detects the abnormality in the operation node 822 by receiving, from the app monitoring unit 823, the notification that the abnormality in the app 824 has been detected.

Alternatively, for example, the monitoring unit 890 performs polling to the operation node 822 by the CloudWatch 891, and detects the abnormality in the operation node 822 itself. When the abnormality in the operation node 822 is detected, the monitoring unit 890 updates the status to “ALARM” by the CloudWatch 891. With this configuration, the information processing system 200 may switch the operation system to obtain a trigger for appropriately continuing to provide the function to a user.

(8-2) When the abnormality in the operation node 822 is detected, the monitoring unit 890 transmits, to the switch control unit 870, a switch request including a notification that the abnormality in the operation node 822 has been detected by the EventBridge 892. The switch control unit 870 receives the switch request from the monitoring unit 890.

(8-3) The switch control unit 870 acquires the environment variable 860 (SYSTEM_LIST, BLACKHOLE) by using the serverless function 871.

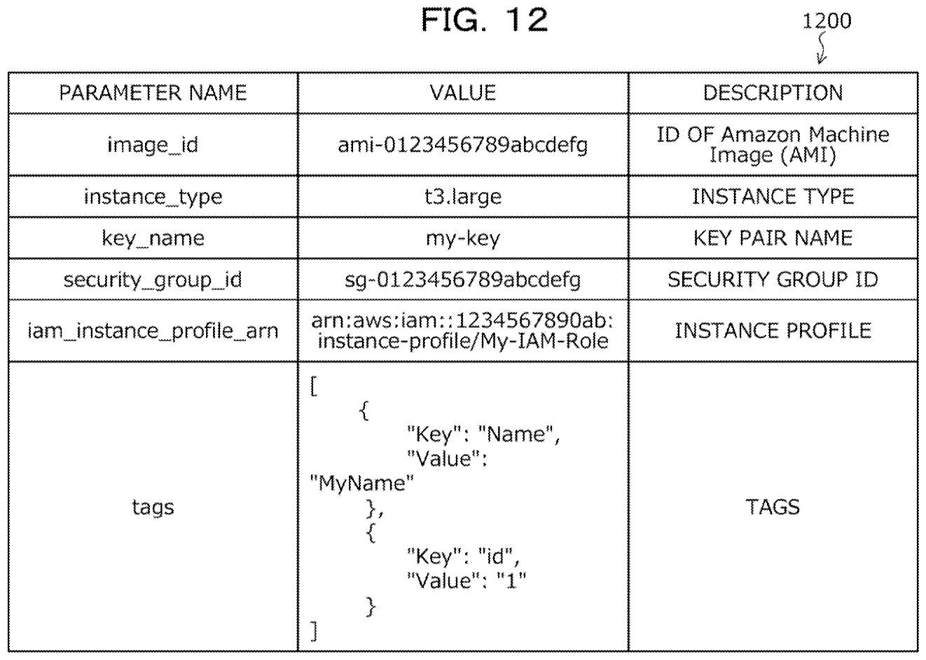

(8-4) The switch control unit 870 executes an API “EC2:DescribeInstances” by using the serverless function 871, and acquires instance information related to the operation node 822 of the switching source. Here, description of FIG. 12 will be made, and an example of the instance information will be described.

FIG. 12 is an explanatory diagram illustrating an example of the instance information. In FIG. 12, the instance information includes various parameters indicated in a table 1200. A parameter “image_id” is, for example, a value “ami-0123456789abcdefg” and indicates an “identifier (ID) of AMI”.

A parameter “instance_type” is, for example, a value “t3.large” and indicates an “instance type”. A parameter “key_name” is, for example, a value “my-key” and indicates a “key pair name”. A parameter “security_group_id” is, for example, a value “sg-0123456789abcdefg” and indicates a “security group ID”.

A parameter “iam_instance_profile_arn” is, for example, a value “arn:aws:iam::1234567890ab:instance-profile/My-IAM-Role” and indicates an “instance profile”. A parameter “tags” indicates tags. Key “id” is, for example, an identifier that identifies the operation node 822.

Returning to the description of FIG. 8, (8-5) the switch control unit 870 executes APIs “elbv2:DescribeTargetGroups” and “elbv2:DescribeTargetHealth” by using the serverless function 871. The switch control unit 870 acquires load balancer information by the APIs “elbv2:DescribeTargetGroups” and “elbv2:DescribeTargetHealth”.

The switch control unit 870 determines, by using the serverless function 871, whether or not a value of Key “id” of the parameter “Tags” included in the instance information is included in the SYSTEM_LIST. When the value of Key “id” of the parameter “Tags” is included in the SYSTEM_LIST, the switch control unit 870 determines that the operation node 822 in which the abnormality has occurred is to be switched, and performs the switch processing. In the example of FIG. 8, it is assumed that the switch control unit 870 determines that the value of Key “id” of the parameter “Tags” is included in the SYSTEM_LIST.

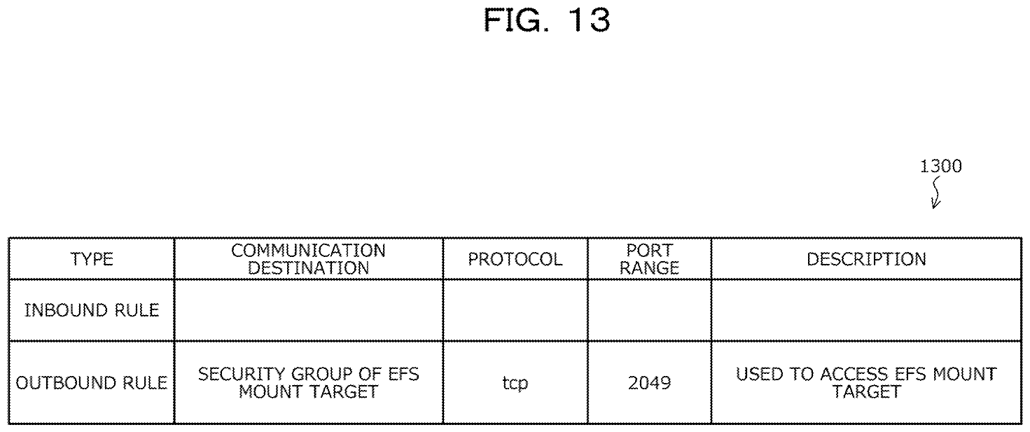

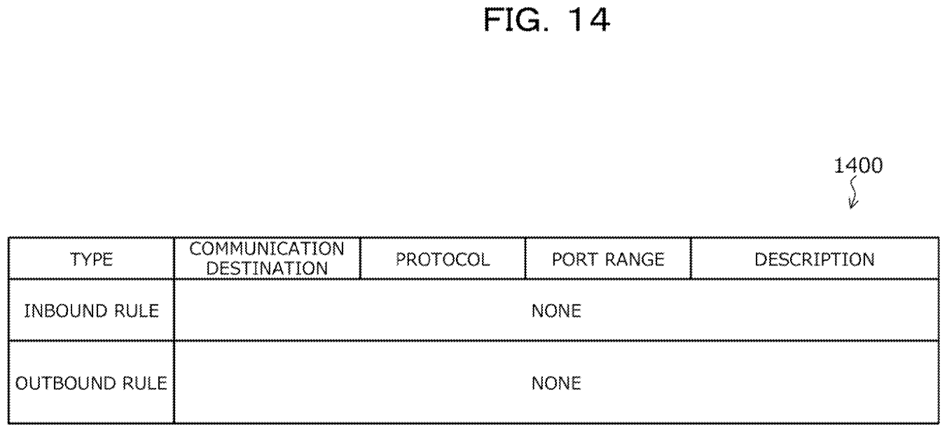

(8-6) The switch control unit 870 executes, by using the serverless function 871, an API “EC2:DescribeSecurityGroups” for the BLACKHOLE to acquire BHSG information. The switch control unit 870 executes, by using the serverless function 871, an API “EC2:ModifyNetworkInterfaceAttribute”. The switch control unit 870 applies the BHSG to an elastic network interface (ENI) that communicates with EFS of the operation node 822 by executing the API “EC2:ModifyNetworkInterfaceAttribute”. Here, description of FIGS. 13 and 14 will be made, and an example of changing the security group in a case where the BHSG is applied will be described.

FIGS. 13 and 14 are explanatory diagrams illustrating an example of changing the security group. A state 1300 of the security group indicated in FIG. 13 corresponds to a normal time before occurrence of an abnormality, and indicates that communication is permitted to a mount target of the EFS, which is the shared volume 840. Next, description of FIG. 14 will be made.

A state 1400 of the security group indicated in FIG. 14 corresponds to after occurrence of the abnormality, and indicates that communication is not permitted to the mount target of the EFS, which is the shared volume 840, and indicates that IO is blocked. When the BHSG is applied to the ENI that communicates with the EFS of the operation node 822, the security group is updated from the state 1300 to the state 1400.

When the control unit 825 is normal, the control unit 825 controls various types of traffic related to the operation node 822 according to the security group in the state 1300. When the operation node 822 is abnormal, the control unit 825 blocks various types of traffic related to the operation node 822 according to the security group in the state 1400.

Returning to the description of FIG. 8, (8-7) the switch control unit 870 executes an API “EC2:TerminateInstances” by using the serverless function 871, and issues a request to discard the operation node 822.

(8-8) The switch control unit 870 does not need to wait for completion of discard of the operation node 822 when the BHSG has been successfully applied. The switch control unit 870 executes an API “EC2:RunInstances” by using the serverless function 871 without waiting for completion of discard of the operation node 822, and creates a standby node 832 of a switching destination based on the instance information.

For example, the switch control unit 870 prepares a subnet 831 “10.0.1.0/24”, and creates, in the subnet 831, the standby node 832 including an app 834 having the same function as the function of the app 824. The standby node 832 includes an app monitoring unit 833 similar to the app monitoring unit 823. For example, the switch control unit 870 creates a control unit 835 “security group” in the subnet 831. For example, the switch control unit 870 creates cloud resource configuration information 836 “AMI” in the subnet 831. With this configuration, the information processing system 200 may make it possible to create the standby node 832 early.

Furthermore, the switch control unit 870 waits for completion of discard of the operation node 822 when application of the BHSG has failed. The switch control unit 870 executes the API “EC2:RunInstances” by using the serverless function 871 after confirming completion of discard of the operation node 822, and creates the standby node 832 of the switching destination based on the instance information.

For example, the switch control unit 870 prepares the subnet 831 “10.0.1.0/24”, and creates, in the subnet 831, the standby node 832 including the app 834 having the same function as the function of the app 824. The standby node 832 includes the app monitoring unit 833 similar to the app monitoring unit 823. For example, the switch control unit 870 creates the control unit 835 “security group” in the subnet 831. For example, the switch control unit 870 creates the cloud resource configuration information 836 “AMI” in the subnet 831. With this configuration, the information processing system 200 may prevent data corruption in the shared volume 840 even when application of the BHSG has failed.

(8-9) The switch control unit 870 executes an API “elbv2:RegisterTargets” by using the serverless function 871, and changes a distribution destination of the NLB to the created standby node. The switch control unit 870 executes an API “CloudWatch:PutMetricAlarm” by using the serverless function 871, and changes a monitoring destination of the CloudWatch alarm to the standby node.

As described above, the information processing system 200 may prohibit communication of the operation node 822 to the shared volume 840 without the operation node 822 or the standby node 832 as a main body, and may prevent data corruption in the shared volume 840. For example, the information processing system 200 may prevent a split brain even in the case of occurrence of a hang-up in the operation node 822, or the like, and may appropriately prevent data corruption in the shared volume 840.

While preventing data corruption in the shared volume 840, the information processing system 200 may discard the operation node 822 in which an abnormality has occurred, create the standby node 832 in place of the operation node 822, and switch the operation system. The information processing system 200 may dispense with preparing the standby node 832 in advance. As a result, the information processing system 200 may promote reduction in a workload imposed on an operator. Furthermore, the information processing system 200 may save a resource use amount of the cloud 800 until the standby node 832 is created when it is actually used.

(Overall Processing Procedure)

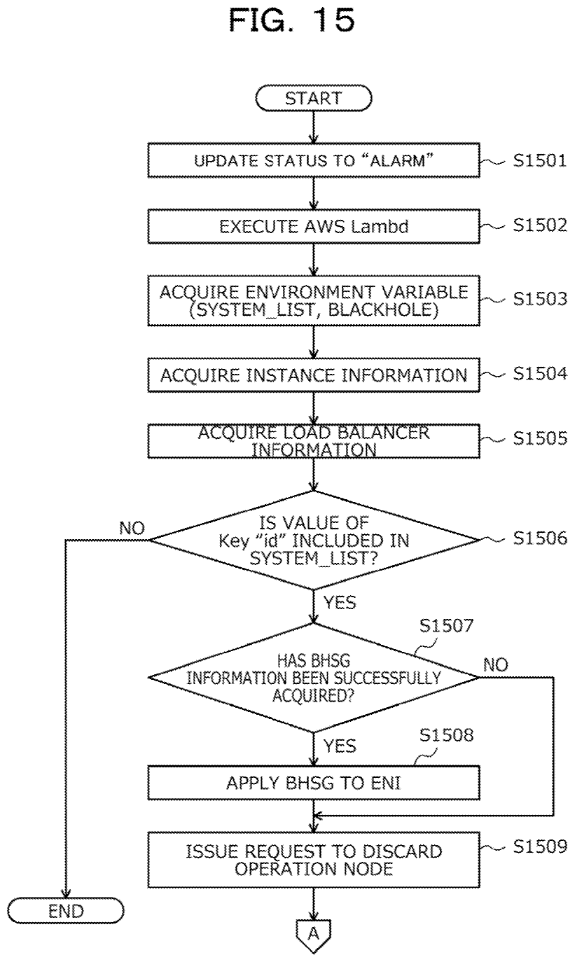

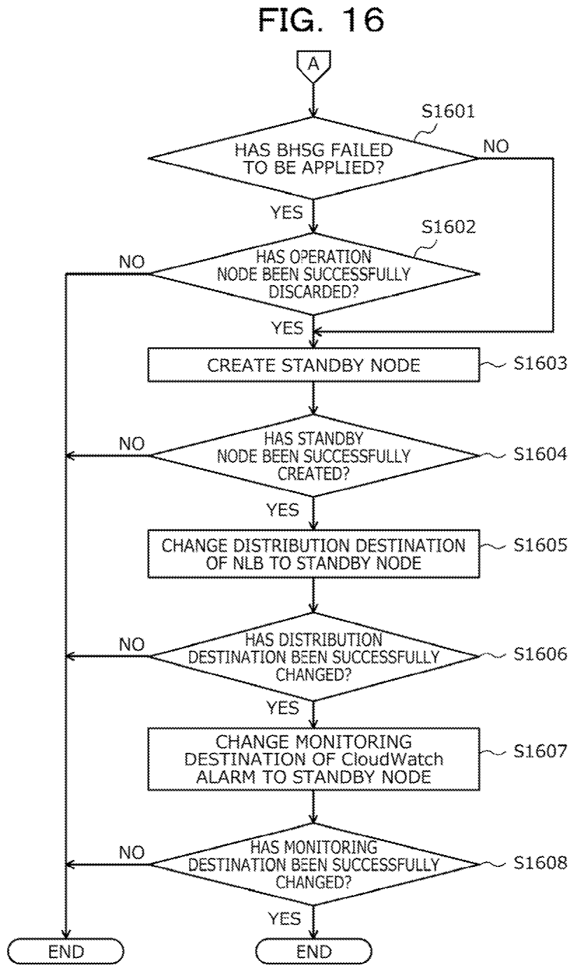

Next, an example of an overall processing procedure executed by the information processing system 200 will be described with reference to FIGS. 15 and 16.

FIGS. 15 and 16 are flowcharts illustrating an example of the overall processing procedure. In FIG. 15, the monitoring unit 890 detects an abnormality in the operation node 822 based on CPU metrics by the CloudWatch 891, and updates a status of the CloudWatch alarm to ALARM (Step S1501). The monitoring unit 890 executes the AWS Lambda by transmitting a switch request to the switch control unit 870 by the EventBridge 892 (Step S1502).

The switch control unit 870 acquires the environment variable 860 (SYSTEM_LIST, BLACKHOLE) by the AWS Lambda (Step S1503). The switch control unit 870 executes the API “EC2:DescribeInstances” by the AWS Lambda, and acquires the instance information related to the operation node 822 of the switching source indicated in FIG. 12 (Step S1504). The switch control unit 870 executes the APIs “elbv2:DescribeTargetGroups” and “elbv2:DescribeTargetHealth” by the AWS Lambda, and acquires load balancer information (Step S1505).

The switch control unit 870 determines, by the AWS Lambda, whether or not the value of Key “id” of the parameter “Tags” included in the instance information is included in the SYSTEM_LIST (Step S1506). Here, in the case of being not included in the SYSTEM_LIST (Step S1506: No), the information processing system 200 ends the overall processing. On the other hand, in the case of being included in the SYSTEM_LIST (Step S1506: Yes), the switch control unit 870 proceeds to processing in Step S1507.

In Step S1507, the switch control unit 870 executes the API “EC2:DescribeSecurityGroups” for the BLACKHOLE by the AWS Lambda. The switch control unit 870 determines, by the API “EC2:DescribeSecurityGroups”, whether or not the BHSG information has been successfully acquired (Step S1507).

Here, in a case where the acquisition has failed (Step S1507: No), the switch control unit 870 proceeds to processing in Step S1509. On the other hand, in a case where the acquisition has succeeded (Step S1507: Yes), the switch control unit 870 proceeds to processing in Step S1508.

In Step S1508, the switch control unit 870 executes the API “EC2:ModifyNetworkInterfaceAttribute” by the AWS Lambda. The switch control unit 870 applies the BHSG to the ENI that communicates with the EFS of the operation node 822 by the API “EC2:ModifyNetworkInterfaceAttribute”, and updates the security group to the state 1400 (Step S1508).

In Step S1509, the switch control unit 870 executes the API “EC2:TerminateInstances” by the AWS Lambda, and issues a request to discard the operation node 822 (Step S1509). Next, description of FIG. 16 will be made.

In FIG. 16, the switch control unit 870 determines, by the AWS Lambda, whether or not the BHSG has failed to be applied (Step S1601). Here, in a case where the application has failed (Step S1601: Yes), the switch control unit 870 proceeds to processing in Step S1602. On the other hand, in a case where the application has succeeded (Step S1601: No), the switch control unit 870 proceeds to processing in Step S1603.

In Step S1602, the switch control unit 870 determines, by the AWS Lambda, whether or not the operation node 822 has been successfully discarded (Step S1602). Here, in a case where the discard has succeeded (Step S1602: Yes), the switch control unit 870 proceeds to the processing in Step S1603. On the other hand, in a case where the discard has failed (Step S1602: No), the information processing system 200 determines that switching of the operation system has failed, and ends the overall processing.

In Step S1603, the switch control unit 870 executes the API “EC2:RunInstances” by the AWS Lambda, and creates a standby node of a switching destination based on the instance information (Step S1603).

The switch control unit 870 determines whether or not the standby node has been successfully created (Step S1604). Here, in a case where the creation has succeeded (Step S1604: Yes), the switch control unit 870 proceeds to processing in Step S1605. On the other hand, in a case where the creation has failed (Step S1604: No), the information processing system 200 determines that switching of the operation system has failed, and ends the overall processing.

In Step S1605, the switch control unit 870 executes the API “elbv2:RegisterTargets” by the AWS Lambda, and changes a distribution destination of the NLB to the created standby node (Step S1605).

The switch control unit 870 determines whether or not the distribution destination of the NLB has been successfully changed (Step S1606). Here, in a case where the change has succeeded (Step S1606: Yes), the switch control unit 870 proceeds to processing in Step S1607. On the other hand, in a case where the change has failed (Step S1606: No), the information processing system 200 determines that switching of the operation system has failed, and ends the overall processing.

In Step S1607, the switch control unit 870 executes the API “CloudWatch:PutMetricAlarm” by the AWS Lambda, and changes a monitoring destination of the CloudWatch alarm to the standby node (Step S1607).

The switch control unit 870 determines, by the AWS Lambda, whether or not the monitoring destination of the CloudWatch alarm has been successfully changed (Step S1608). Here, in a case where the change has succeeded (Step S1608: Yes), the switch control unit 870 determines that switching of the operation system has succeeded, and ends the overall processing. On the other hand, in a case where the change has failed (Step S1608: No), the information processing system 200 determines that switching of the operation system has failed, and ends the overall processing.

(Second Operation Example of Information Processing System 200)

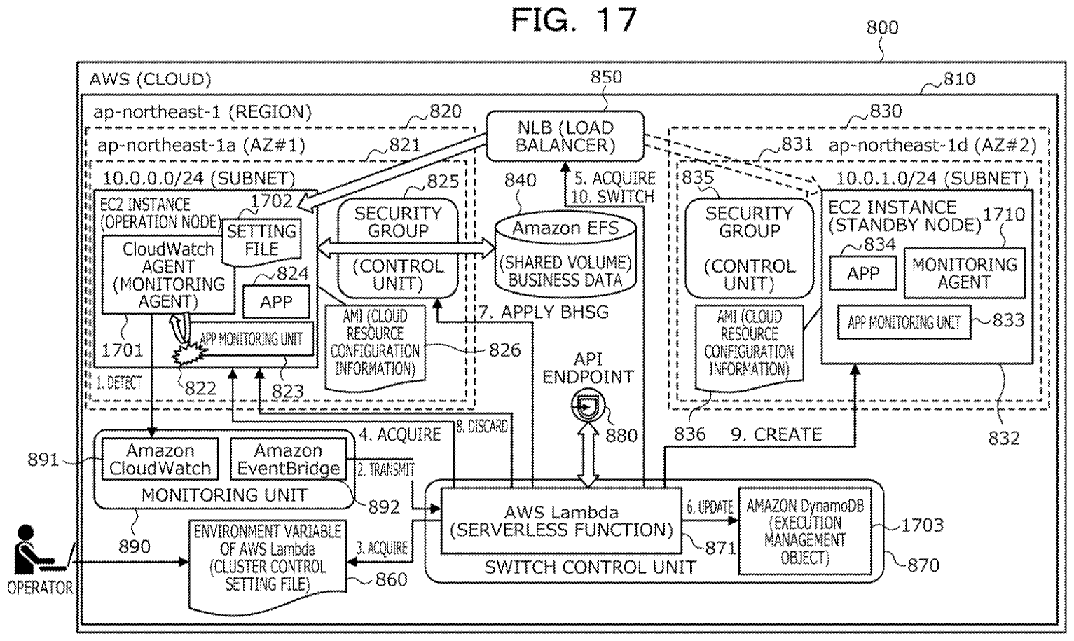

Next, a second operation example of the information processing system 200 will be described with reference to FIGS. 17 to 19. The second operation example is a specific example in which it is made possible to cope with a case where a plurality of abnormalities occurs in the operation node 822 in the cloud 800.

FIG. 17 is a block diagram illustrating a specific functional configuration example of the information processing system 200 in the second operation example. In FIG. 17, elements similar to those in FIG. 8 are denoted by the same reference signs as those in FIG. 8. In the following description, description of the elements similar to those in FIG. 8 may be omitted.

In FIG. 17, the cloud 800 “AWS” including a plurality of resources exists. The cloud 800 includes the region 810 “ap-northeast-1”. The region 810 includes the AZ 820 “ap-northeast-1a” and the AZ 830 “ap-northeast-1d”. The AZ 820 is, for example, a collection of data centers. The AZ 830 is, for example, a collection of data centers.

The AZ 820 includes the subnet 821. The subnet 821 is the range in which the IP address “10.0.0.0/24” is allocated. The subnet 821 includes the operation node 822 “EC2 instance”.

The operation node 822 executes, for example, the app 824 which is a business application. The operation node 822 is, for example, a virtual server. The operation node 822 is implemented by, for example, resources included in the cloud 800. For example, the operation node 822 is implemented by resources included in the AZ 820 of the cloud 800. The operation node 822 includes the app monitoring unit 823.

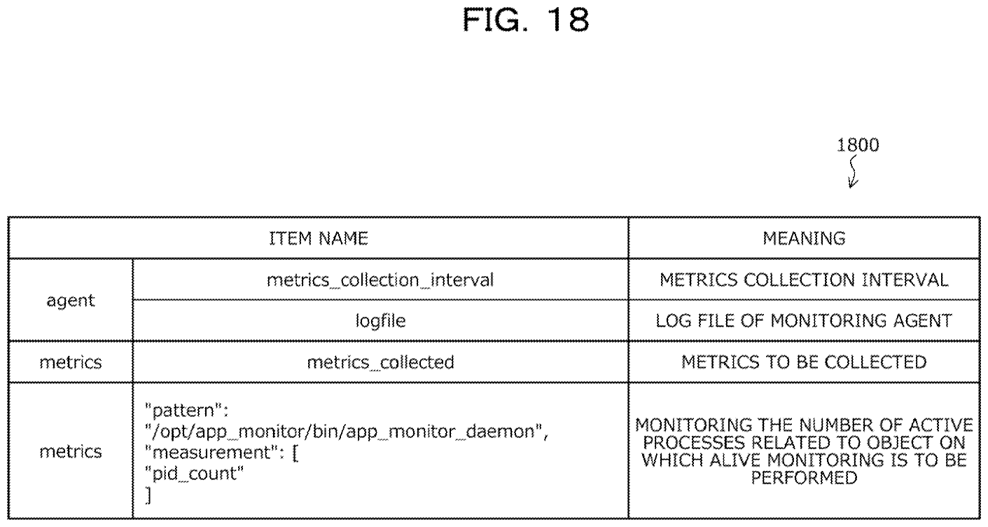

The operation node 822 includes a monitoring agent 1701 “CloudWatch Agent”. The monitoring agent 1701 includes a setting file 1702. The monitoring agent 1701 is a monitoring system that refers to the setting file 1702, collects custom metrics, and provides the custom metrics to the CloudWatch 891. The monitoring agent 1701 make it possible to perform alive monitoring of the app monitoring unit 823 by collecting the custom metrics, for example. Here, description of FIG. 18 will be made, and an example of an item of the setting file 1702 will be described.

FIG. 18 is an explanatory diagram illustrating an example of the item. In FIG. 18, the setting file 1702 defines various items indicated in a table 1800. For example, an item “agent: metrics_collection_interval” indicates a “metrics collection interval”. An item “agent:logfile” indicates a “log file of the monitoring agent 1701”. An item “metrics:metrics_collected” indicates “metrics to be collected”.

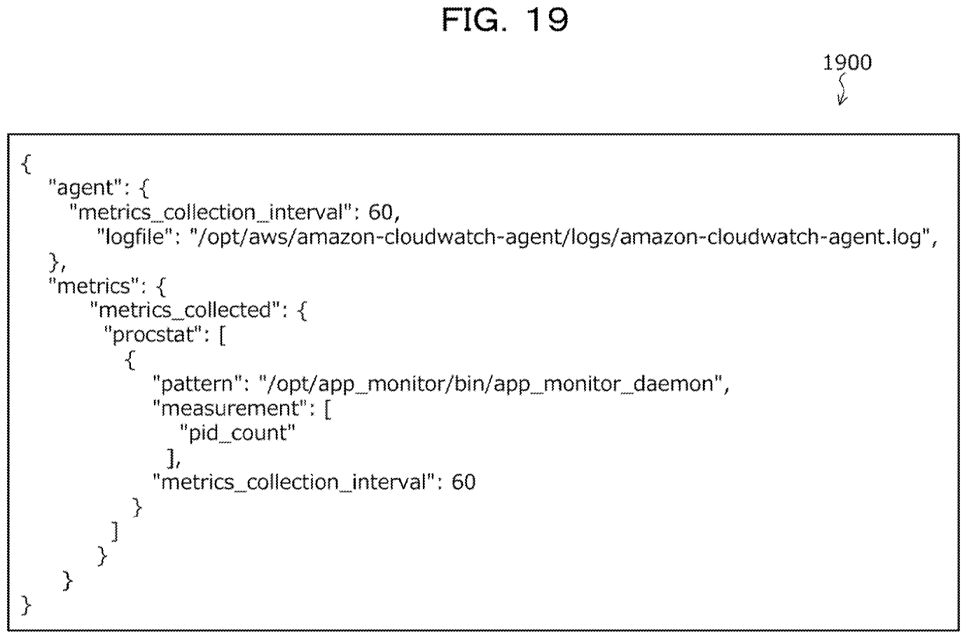

Furthermore, an item “metrics:“pattern”: “/opt/app_monitor/bin/app_monitor_daemon”,“measurement”: [“pid_count”]” exists. The item indicates “monitoring the number of active processes related to an object on which alive monitoring is to be performed”. Here, description of FIG. 19 will be made, and an example of a value of each item of the setting file 1702 will be described.

FIG. 19 is an explanatory diagram illustrating an example of the value of each item. The value of each item is specified as in JavaScript Object Notation (JSON) format data 1900 indicated in FIG. 19. The value of each item is preset by, for example, an operator. For example, the monitoring agent 1701 refers to the value of each item and collects the custom metrics. With this configuration, the information processing system 200 may also include the app monitoring unit 823 as an object to be monitored.

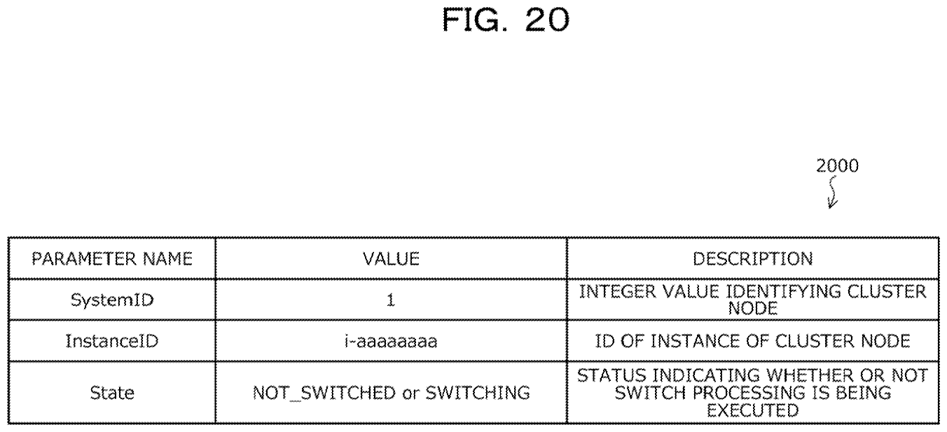

Here, returning to the description of FIG. 17, the region 810 includes the switch control unit 870. The switch control unit 870 includes the serverless function 871 “AWS Lambda”. The serverless function 871 is, for example, the AWS Lambda defined by the AWS. The switch control unit 870 is implemented by, for example, resources included in the cloud 800. The switch control unit 870 includes an execution management object 1703 “Amazon DynamoDB (DataBase)”. The execution management object 1703 is a DB that manages an execution state of the switch processing. Next, an example of the execution management object 1703 will be described with reference to FIG. 20.

FIG. 20 is an explanatory diagram illustrating an example of the execution management object 1703. In FIG. 20, the execution management object 1703 includes values of various parameters indicated in a table 2000. A parameter “SystemID” is, for example, a value “1” and indicates an “integer value identifying a cluster node”. The cluster node is, for example, the operation node 822.

A parameter “InstanceID” is, for example, a value “i-aaaaaaaa” and indicates an “ID of an instance of the cluster node”. A parameter “State” is, for example, a value “NOT_SWITCHED” or “SWITCHING” and indicates a “status indicating whether or not the switch processing is being executed for the cluster node”.

Here, returning to the description of FIG. 17, (17-1) the monitoring unit 890 acquires, by the CloudWatch 891, the custom metrics from the monitoring agent 1701.

The monitoring unit 890 detects, by the CloudWatch 891, an abnormality in the operation node 822 based on the custom metrics. The abnormality in the operation node 822 is, for example, an abnormality in the app monitoring unit 823. For example, the monitoring unit 890 performs, by the CloudWatch 891, alive monitoring of the app monitoring unit 823 based on the custom metrics, and detects the abnormality in the app monitoring unit 823.

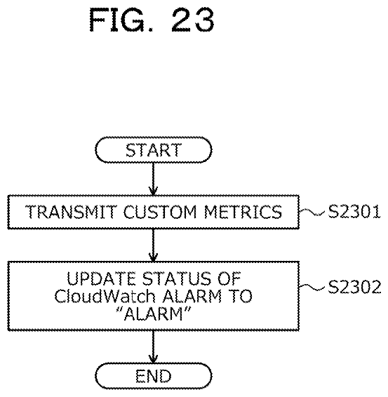

When the abnormality in the operation node 822 is detected, the monitoring unit 890 updates the status to “ALARM” by the CloudWatch 891. Content of the processing by which the information processing system 200 detects the abnormality in the app monitoring unit 823 will be described later with reference to FIG. 23. With this configuration, the information processing system 200 may switch the operation system to obtain a trigger for appropriately continuing to provide the function to a user.

(17-2) When the abnormality in the operation node 822 is detected, the monitoring unit 890 transmits, to the switch control unit 870, a switch request including a notification that the abnormality in the operation node 822 has been detected by the EventBridge 892. The switch control unit 870 receives the switch request from the monitoring unit 890.

(17-3) The switch control unit 870 acquires the environment variable 860 (SYSTEM_LIST, BLACKHOLE) by using the serverless function 871.

(17-4) The switch control unit 870 executes the API “EC2:DescribeInstances” by using the serverless function 871, and acquires instance information related to the operation node 822 of the switching source.

(17-5) The switch control unit 870 executes the APIs “elbv2:DescribeTargetGroups” and “elbv2:DescribeTargetHealth” by using the serverless function 871. The switch control unit 870 acquires load balancer information by the APIs “elbv2:DescribeTargetGroups” and “elbv2:DescribeTargetHealth”.

The switch control unit 870 determines, by using the serverless function 871, whether or not a value of Key “id” of the parameter “Tags” included in the instance information is included in the SYSTEM_LIST. When the value of Key “id” of the parameter “Tags” is included in the SYSTEM_LIST, the switch control unit 870 determines that the operation node 822 in which the abnormality has occurred is to be switched. In the example of FIG. 17, it is assumed that the switch control unit 870 determines that the value of Key “id” of the parameter “Tags” is included in the SYSTEM_LIST.

(17-6) The switch control unit 870 determines that the operation node 822 in which the abnormality has occurred is to be switched, and updates the execution management object 1703 when proceeding to the switch processing. For example, the switch control unit 870 executes an API “dynamodb:TransactWriteItems” by using the serverless function 871, and acquires the item “state” of the instance to be switched from the execution management object 1703.

When the acquired item “state” is not NOT_SWITCHED, the switch control unit 870 determines that the existing switch processing is being executed, and avoids that new and redundant switch processing is executed. When the acquired item “state” is NOT_SWITCHED, the switch control unit 870 determines that the existing switch processing is not being executed, and determines that new switch processing may be executed.

Here, it is assumed that the switch control unit 870 determines that new switch processing may be executed. The switch control unit 870 executes the API “dynamodb:TransactWriteItems” by using the serverless function 871, and updates the item “state” of the instance to be switched to SWITCHED. With this configuration, the information processing system 200 may perform control so that a plurality of types of switch processing is not executed redundantly at the same time, and may promote improvement in stability of the information processing system 200.

(17-7) The switch control unit 870 executes, by using the serverless function 871, the API “EC2:DescribeSecurityGroups” for the BLACKHOLE to acquire BHSG information. The switch control unit 870 executes the API “EC2:ModifyNetworkInterfaceAttribute” by using the serverless function 871, and applies the BHSG to the ENI that communicates with the EFS of the operation node 822. With this configuration, the information processing system 200 may prevent data corruption in the shared volume 840.

(17-8) The switch control unit 870 executes the API “EC2:TerminateInstances” by using the serverless function 871, and issues a request to discard the operation node 822. With this configuration, the information processing system 200 may save a resource use amount of the cloud 800. Furthermore, the information processing system 200 may facilitate prevention of data corruption in the shared volume 840.

(17-9) The switch control unit 870 does not need to wait for completion of discard of the operation node 822 when the BHSG has been successfully applied. The switch control unit 870 executes the API “EC2:RunInstances” by using the serverless function 871 without waiting for completion of discard of the operation node 822, and creates the standby node 832 of the switching destination based on the instance information.

For example, the switch control unit 870 prepares the subnet 831 “10.0.1.0/24”, and creates, in the subnet 831, the standby node 832 including the app 834 having the same function as the function of the app 824. The standby node 832 includes the app monitoring unit 833 similar to the app monitoring unit 823. For example, the switch control unit 870 creates the control unit 835 “security group” in the subnet 831. For example, the switch control unit 870 creates the cloud resource configuration information 836 “AMI” in the subnet 831. With this configuration, the information processing system 200 may make it possible to create the standby node 832 early.

Furthermore, the switch control unit 870 waits for completion of discard of the operation node 822 when application of the BHSG has failed. The switch control unit 870 executes the API “EC2:RunInstances” by using the serverless function 871 after confirming completion of discard of the operation node 822, and creates the standby node 832 of the switching destination based on the instance information.

For example, the switch control unit 870 prepares the subnet 831 “10.0.1.0/24”, and creates, in the subnet 831, the standby node 832 including the app 834 having the same function as the function of the app 824. The standby node 832 includes the app monitoring unit 833 similar to the app monitoring unit 823. The standby node 832 includes a monitoring agent 1710 similar to the monitoring agent 1701.

For example, the switch control unit 870 creates the control unit 835 “security group” in the subnet 831. For example, the switch control unit 870 creates the cloud resource configuration information 836 “AMI” in the subnet 831. With this configuration, the information processing system 200 may prevent data corruption in the shared volume 840 even when application of the BHSG has failed.

(17-10) The switch control unit 870 executes the API “elbv2:RegisterTargets” by using the serverless function 871, and changes a distribution destination of the NLB to the created standby node. The switch control unit 870 executes an API “CloudWatch:PutMetricAlarm” by using the serverless function 871, and changes a monitoring destination of the CloudWatch alarm to the standby node.

Here, the switch control unit 870 updates the execution management object 1703 when ending the switch processing. For example, the switch control unit 870 executes the API “dynamodb:TransactWriteItems” by using the serverless function 871, and updates the item “state” of the instance to be switched to NOT_SWITCHED.

The switch control unit 870 executes the API “dynamodb:TransactWriteItems” by using the serverless function 871, and updates the item “instanceID” of the instance to be switched to an ID of a newly created instance. With this configuration, the information processing system 200 may make it possible to manage, by the execution management object 1703, whether or not the switch processing for the standby node 832 is being executed.

As described above, the information processing system 200 may prohibit communication of the operation node 822 to the shared volume 840 without the operation node 822 or the standby node 832 as a main body, and may prevent data corruption in the shared volume 840. For example, the information processing system 200 may prevent a split brain even in the case of occurrence of a hang-up in the operation node 822, or the like, and may appropriately prevent data corruption in the shared volume 840.

While preventing data corruption in the shared volume 840, the information processing system 200 may discard the operation node 822 in which an abnormality has occurred, create the standby node 832 in place of the operation node 822, and switch the operation system. The information processing system 200 may dispense with preparing the standby node 832 in advance. As a result, the information processing system 200 may promote reduction in a workload imposed on an operator. Furthermore, the information processing system 200 may save a resource use amount of the cloud 800 until the standby node 832 is created when it is actually used.

The information processing system 200 may avoid redundant execution of the switch processing, and may promote reduction in a processing load. Furthermore, the information processing system 200 may avoid redundant execution of the switch processing, may prevent interference of a different type of switch processing and occurrence of a malfunction in the switch processing, and may promote improvement in stability of the information processing system 200. The information processing system 200 may also include the app monitoring unit 823 as an object to be monitored, and may make it possible to cope with various abnormalities related to the operation node 822.

(Overall Processing Procedure in Second Operation Example)

For example, an example of an overall processing procedure in the second operation example is similar to an example of the overall processing procedure in the first operation example illustrated in FIGS. 15 and 16.

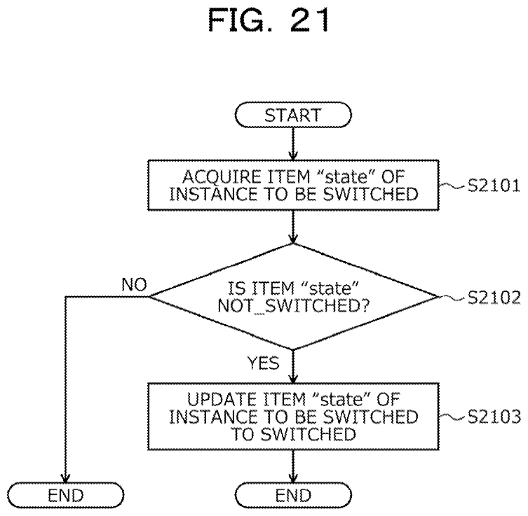

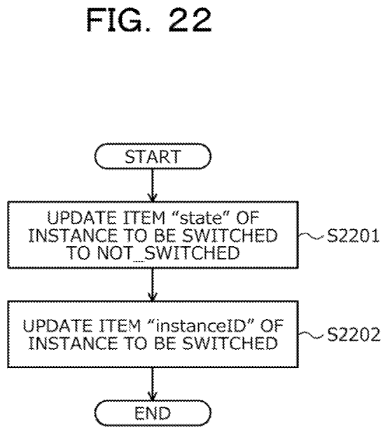

In the overall processing in the second operation example, for example, lock processing, which will be described later with reference to FIG. 21, is executed between the processing in Step S1506 and the processing in Step S1507. In the overall processing in the second operation example, for example, release processing, which will be described later with reference to FIG. 22, is executed after the processing in Step S1608. In the overall processing in the second operation example, for example, detection processing, which will be described later with reference to FIG. 23, may be executed in place of the processing in Step S1501.

(Lock Processing Procedure)

Next, an example of a lock processing procedure executed by the information processing system 200 will be described with reference to FIG. 21.

FIG. 21 is a flowchart illustrating an example of the lock processing procedure. In FIG. 21, the switch control unit 870 executes the API “dynamodb:TransactWriteItems” by the AWS Lambda, and acquires the item “state” of the instance to be switched (Step S2101). The switch control unit 870 acquires the item “state” of the instance to be switched from, for example, the execution management object 1703.

The switch control unit 870 determines whether or not the acquired item “state” is NOT_SWITCHED (Step S2102). Here, in a case where the item “state” is not NOT_SWITCHED (Step S2102: No), the switch control unit 870 ends the lock processing. On the other hand, in a case where the item “state” is NOT_SWITCHED (Step S2102: Yes), the switch control unit 870 proceeds to processing in Step S2103.

In Step S2103, the switch control unit 870 executes the API “dynamodb:TransactWriteItems” by the AWS Lambda, and updates the item “state” of the instance to be switched to SWITCHED (Step S2103). Then, the information processing system 200 ends the lock processing. With this configuration, the information processing system 200 may manage, by the execution management object 1703, that the switch processing is being executed.

(Release Processing Procedure)

Next, an example of a release processing procedure executed by the information processing system 200 will be described with reference to FIG. 22.

FIG. 22 is a flowchart illustrating an example of the release processing procedure. In FIG. 22, the switch control unit 870 executes the API “dynamodb:TransactWriteItems” by the AWS Lambda, and updates the item “state” of the instance to be switched to NOT_SWITCHED (Step S2201).

The switch control unit 870 executes the API “dynamodb:TransactWriteItems” by the AWS Lambda, and updates the item “instanceID” of the instance to be switched (Step S2202). The switch control unit 870 updates, for example, the item “instanceID” of the instance to be switched to an ID of a newly created instance. Then, the information processing system 200 ends the release processing.

(Detection Processing Procedure)

Next, an example of a detection processing procedure executed by the information processing system 200 will be described with reference to FIG. 23.

FIG. 23 is a flowchart illustrating an example of the detection processing procedure. In FIG. 23, the monitoring agent 1701 transmits custom metrics (Step S2301). The CloudWatch 891 receives the custom metrics, detects an abnormality based on the custom metrics, and updates a status of the CloudWatch alarm to “ALARM” (Step S2302). The information processing system 200 ends the detection processing.

As described above, according to the control unit 430, it is possible to receive a notification in response to an abnormality in the first system on the cloud. According to the control unit 430, it is possible to block, in response to receiving the notification, input/output of the first system by using use the serverless function, and perform the switch processing of creating, on the cloud, the second system to which the function of the first system is shifted. With this configuration, the control unit 430 may prevent data corruption in the storage used by the first system.

According to the control unit 430, it is possible to block, in response to receiving the notification, input/output of the first system by setting communication prohibition of the first system by using the serverless function. With this configuration, the control unit 430 may facilitate quick blocking of input/output of the first system.

According to the control unit 430, in a case where the communication prohibition of the first system has been successfully set, it is possible to discard the first system while the switch processing of creating the second system is performed. With this configuration, the control unit 430 may facilitate early creation of the second system without waiting for completion of discard of the first system.

According to the control unit 430, in a case where the communication prohibition of the first system has failed to be set, it is possible to perform the switch processing of creating the second system after the first system is discarded. With this configuration, the control unit 430 may prevent data corruption in the storage used by the first system even when the communication prohibition of the first system has failed to be set.

According to the control unit 430, in response to receiving second and subsequent notifications, it is possible to discard the second and subsequent notifications without redundantly performing the switch processing of creating the second system. With this configuration, the control unit 430 may avoid redundant performance of the switch processing, and may promote improvement in stability of the information processing system 200.

According to the control unit 430, it is possible to perform the switch processing including switching a distribution destination of communication from the first system to the second system. With this configuration, the control unit 430 may appropriately switch the operation system.

Note that the information processing method described in the present embodiment may be implemented by executing a program prepared in advance on a computer such as a PC or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like. Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
receiving a notification in response to an abnormality in a first system on a cloud; and
blocking, in response to the reception of the notification, input and output of the first system by using a serverless function that creates a system by using resources on the cloud, and performing switch processing of creating, on the cloud, a second system to which a function of the first system is shifted.

2. The non-transitory computer-readable recording medium according to claim 1, wherein,
in the processing of performing,
in response to the reception of the notification, input and output of the first system is blocked by setting communication prohibition of the first system by using the serverless function.

3. The non-transitory computer-readable recording medium according to claim 2, wherein,
in the processing of performing,
in a case where the communication prohibition of the first system has been successfully set, the first system is discarded while the switch processing of creating the second system is performed.

4. The non-transitory computer-readable recording medium according to claim 2, wherein,
in the processing of performing,
in a case where the communication prohibition of the first system has failed to be set, the switch processing of creating the second system is performed after the first system is discarded.

5. The non-transitory computer-readable recording medium according to claim 1, wherein,
in the processing of performing,
in response to reception of second and subsequent notifications, the second and subsequent notifications are discarded without redundantly performing the switch processing of creating the second system.

6. The non-transitory computer-readable recording medium according to claim 1, wherein the switch processing includes switching a distribution destination of communication from the first system to the second system.

7. An information processing method comprising:
receiving a notification in response to an abnormality in a first system on a cloud; and
blocking, in response to the reception of the notification, input and output of the first system by using a serverless function that creates a system by using resources on the cloud, and performing switch processing of creating, on the cloud, a second system to which a function of the first system is shifted.

8. A system comprising:
a first system created by using resources on a cloud;
a monitoring circuit that monitors the first system; and
a processor, wherein
the monitoring circuit
detects an abnormality in the first system, and
transmits a notification in response to the abnormality in the first system to the processor, and
the processor
receives, from the monitoring circuit, the notification in response to the abnormality in the first system, and
blocks, in response to the reception of the notification, input and output of the first system by using a serverless function that creates a system by using one or more of the resources on the cloud, and performs switch processing of creating, on the cloud, a second system to which a function of the first system is shifted.
